(19) United States
(12) Patent Application Publication
(10) Pub. No.: US 2006/0088165 A1
(43) Pub. Date: Apr. 27, 2006

(54) Method and apparatus for providing user-friendly information in digital device

(75) Inventors: Sung-min Yoon, Seoul (KR); Baum-sauk Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO, Suwon-si (KR)

(21) Appl. No.: 11/216,092

(22) Filed: Sep. 1, 2005

(30) Foreign Application Priority Data
Sep. 3, 2004 (KR) 10-2004-70346

(51) Int. Cl. H04K 1/00

(52) U.S. Cl. 380/270

(57) ABSTRACT

A method of providing, and an apparatus to provide, information in a user-friendly manner to a user of a digital apparatus, the method including providing an output pattern applicable to a message to be outputted; providing a reference value on which changes in the output pattern are based; and outputting the message by continuously changing the output pattern according to a quantifiable difference between a predetermined value and the reference value.

### CROSS-REFERENCE TO RELATED APPLICATIONS

This application claims the benefit of Korean Patent Application No. 10-2004-70346, filed on Sep. 3, 2004, in the Korean Intellectual Property Office, the disclosure of which is incorporated herein by reference.

### BACKGROUND OF THE INVENTION

1. Field of the Invention

Apparatuses and methods consistent with the present invention relate to a method of providing, and an apparatus to provide, information in a user friendly manner in a digital device.

2. Description of the Related Art

Most data used in current times is digital. Digitalization is not confined only to computers as analog data such as sound and images can be digitalized. Due to this trend, larger and larger amounts of data are being digitalized.

Digital data can be thought of as a string of 0s and 1s. However, people think in a continuous, rather than discrete, manner, and therefore human beings are accustomed to analog rather than digital representation. Nevertheless, digital data is quickly approaching the quality of analog data. To move content within a window horizontally or vertically using a scroll bar may be regarded as an interface to correspond to human beings' analogical mind.

Recently, studies on user interfaces have found that user-friendly constructions are the most efficient user interfaces, and they strongly appeal to people. However, provision of information to users in digital devices is still limited to digital representation. For example, when a user is informed of an appointed time according to a schedule, a method of displaying information through a pop-up display or an alarm function prior to or at the appointed time can be used. As another example, when indicating the battery capacity of a notebook computer or a cellar phone, the remaining quantity thereof may be divided into several levels, whereby the current level of the battery is indicated.

Referring to Korean Unexamined Patent Publication No. 10-2004-44769, an interval for alarm is registered along with a schedule or an appointment. Prior intervals of 6 hours, one day, two days, three days, and one week are supported. Also, a time interval may be set by a user as desired. However, according to this method, the user can only recognize at the predetermined time how much time remains until the appointed time from the instant at which the alarm is shown. That is, discrete and dispersed alarm information is given to the user, and the information cannot be gradually provided over time.

This discrete method may be less desirable to people who are accustomed to continuous change. For this reason, there is a need for a method and an apparatus that can provide information in a user-friendly manner employing an analog representation of data showing continuous change.

### SUMMARY OF THE INVENTION

An aspect of the present invention is to provide user-friendly information.

Another aspect of the present invention is to analogically represent information as it continuously changes.

Additional aspects and/or advantages of the invention will be set forth in part in the description which follows and, in part, will be apparent from the description, or may be learned by practice of the invention.

According to an aspect of the present invention, there is provided a method of user-friendly providing information to a user in a digital apparatus, the method comprising providing an output pattern applicable to a message to be outputted, providing a reference time on which changes in output pattern are based, and outputting the message by continuously changing the output pattern according to a time difference between a predetermined time and the reference time.

According to another aspect of the present invention, there is provided a digital apparatus, the apparatus comprising a set-up unit to set a message to be outputted, an output pattern to be applied to the message, and a reference time on which changes in output pattern are based; and an output unit to output the message by continuously changing the output pattern according to a time difference between a predetermined time and the reference time.

According to another aspect of the present invention, there is provided a digital apparatus, the apparatus comprising, a setup unit to set a message to be outputted, an output pattern to be applied to the message, and a reference time on which changes in output pattern are based; and a transmitting unit to transmit, to a client, an object including the message, the output pattern, and the reference time.

According to another aspect of the present invention, there is provided a digital apparatus, the apparatus comprising, a receiving unit to receive an object for output information including a message to be outputted, an output pattern, and a reference time, from a server; and an output unit to output the message by continuously changing the output pattern according to a time difference between a predetermined time and the reference time.

According to another aspect of the present invention, there is provided a method of providing information in a user-friendly manner to a user of a digital apparatus, the method comprising providing an output pattern applicable to a message to be outputted; providing a reference value on which changes in the output pattern are based; and outputting the message by continuously changing the output pattern according to a quantifiable difference between a predetermined value and the reference value.

According to another aspect of the present invention, there is provided a digital apparatus comprising a setup unit to set a message to be outputted and an output pattern to be applied to the message; and an output unit to output the message by continuously changing the output pattern according to a quantifiable difference between a predetermined value and a reference value.

According to another aspect of the present invention, there is provided a method of providing information in a user-friendly manner to a user of a digital apparatus, the method comprising providing an output pattern applicable to a message to be outputted; and outputting the message by continuously changing the output pattern according to a quantifiable difference between a predetermined value and a current value.

The message and output pattern may be provided by the digital apparatus to a client device, and the message may be output by the client device. The client device may be a light producing device, a hand held computing device, or a cellular phone.

According to another aspect of the present invention, there is provided a digital apparatus comprising a setup unit to set an output pattern to be applied to a message; and an output unit to output the message by continuously changing the output pattern according to a quantifiable difference between a predetermined value and a current value.

The message may be displayed on a part of the digital apparatus, or may be displayed through a second device which communicates with the digital apparatus. The second device may be a light producing device, a hand held computing device, or a cellular phone.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the notification of the approach of an appointed time using an analog representation in a main display according to an embodiment of the present invention;

FIG. 2 is a block diagram illustrating the notification of the approach of an appointed time using analog representation in an auxiliary or external display according to an embodiment of the present invention;

FIG. 3 is a block diagram illustrating the notification of the approach of an appointed time using analog representation in an auxiliary or an external display according to another embodiment of the present invention;

FIG. 4 is a flow chart of a method to continuously display information according to an embodiment of the present invention;

FIG. 5 is a block diagram illustrating the display of data in a user-friendly manner through a server and a client according to an embodiment of the present invention;

FIG. 6 is a flow chart of a method to set a message and an output pattern of the message in a server according to an embodiment of the present invention;

FIG. 7 is a flow chart of a method to set a message and an output pattern of the message, and to calculate output information on a server side according to an embodiment of the present invention;

FIG. 8 is a block diagram illustrating a structure of a server according to an embodiment of the present invention;

FIG. 9 is a block diagram illustrating a structure of a server and a client according to an embodiment of the present invention; and

FIG. 10 is a block diagram illustrating a structure of a server and a client according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The following terms used throughout this specification will be defined as follows.

External Display

This collectively refers to display units other than the main display to output data in a subject digital device. The “external display” may be present in a different position than the main display, such as, for instance, on a lateral side or a back side of the main display. For example, a technology called extended mobile access (EMA), proposed by Intel Corporation, is available for doing simple operations even when a portable digital device is closed, as one of the mobile internet functions. The external device referenced in the present invention may include EMA technology, and an organic electro-luminescence display (OLED), a liquid crystal display (LCD) or the like may be used. Further, an auxiliary display to display changes in color, but not changes in text information, may be included.

Messages

This refers to information to be transmitted to a user. These messages can change the form of a specific interface by use of, for example, text, pictures, and moving images. “Text” may comprise numerals, general, and special alphabets. “Pictures” may be monochromatic; a part of a title bar on a working window is also regarded as a picture. “Moving pictures” may refer to videos, whose sizes may be enlarged or reduced. “On or off” means that light, colors, and/or sounds are turned on or off. Further, “vibration” of part of a visual display (as opposed to actual vibration of the device itself) may also be a message. Messages are output by a digital device by through software or hardware, and they may include messages displayed in an external display. As an example, the brightness of a lamp can be a message.

Output Pattern

This refers to a pattern to output messages, meaning information in connection with the coordination of saturation, luminosity, brightness, RGB colors, sound volume, and other attributes. In a case in which information to be transmitted through a message varies continuously over time, it may be necessary to continuously change and output the information regarding saturation, luminosity, brightness, and so on in order to represent these changes continuously. For example, to indicate that the appointed time is approaching, the saturation may increase or decrease, and the output pattern includes this change. This information may be embodied in various manners depending upon the mechanism used to output it. By way of example, RGB colors may be coordinated by sequentially increasing or decreasing the values of a specific element.

Output & Display

This refers to a method of representing changes by use of a specific output device. Changes in colors, flickering, sound, and/or vibration of a specific portion of a screen may be outputted or displayed. “Output” and “display” referenced in this specification imply that data is represented through an output device.

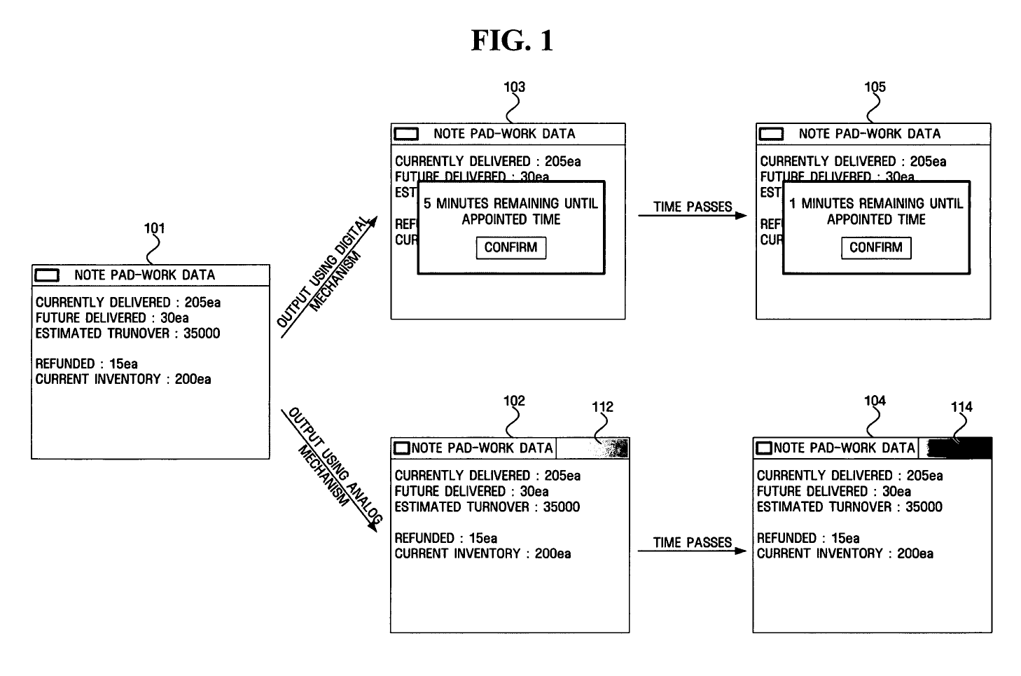

FIG. 1 is a block diagram illustrating the notification of the approach of an appointed time using an analog representation in a main display according to an embodiment of the present invention.

A window numbered 101 (Window 101) is a working window in which a user is currently working. This may be, for example, a working window of the WINDOWS® operating system provided by Microsoft Corporation, or the X Window System™. This may also be a current menu in a device such, for example, a cellular phone or a personal digital assistant (PDA). Windows numbered 103 and 105 (Window 103 and Window 105) illustrate methods of notifying the user of an appointment based on a conventional digital representation. Window 103 illustrates a sub-window to notify a user that five minutes remain until the appointed time. Window 105 illustrates a sub-window to notify the user that one minute remains until the appointed time.

Windows 102 and 104 (Window 102 and Window 104) illustrate methods of notifying the user of the appointed time based on an analog representation. Window 102 assumes that five minutes remain until the appointed time, as in Window 103. A part or the entire title bar of a window numbered 112 (Window 112) may indicate the remaining time with a visual attribute such as one or more colors. In the example of Window 104, assuming that one minute remains until the appointed time, a part or the entire title bar may indicate the remaining time with these one or more colors. Alternatively, as another example, the windows numbered 112 and 114 (Window 112 and Window 114) may indicate the remaining time by varying the darkness and brightness of the colors, the variations indicating that the appointed time is approaching. For example, Window 112 may display light colors such as yellow or green, while Window 114 may display dark colors such as red or blue. Through these changes in the colors of the title bars of Windows 112 and 114, the user can recognize that the appointed time is approaching.

Windows 102 and 104 are graphics illustrating an example of the message. Darkness and brightness of the colors is an example of an output pattern associated with the message.

Using analog representation a user can recognize through attributes such as changes in the colors of the title bar that the appointed time is approaching, without being interrupted in his or her work by a pop-up window.

FIG. 1 illustrates an example in which a user is notified of the approach of the appointed time, but this is merely an example of one embodiment, and the present invention is not limited to this. The remaining power of a battery in a notebook computer, information regarding weather, stocks, and transportation, etc., are other examples of the types of information that may be displayed. In the case of weather, changes in temperature can be displayed, for example, using the analog representation with matching colors. In the case of stocks, for example, a target price may be set, and it may be set so that the colors become darker as the market price approaches the target price. These are all examples of the many types of information that can be transmitted through messages.

The information about weather, stocks, and other values may be included in information received through a digital broadcasting channel, or it may be received by a specific communication program. In addition, values such as the remaining power of a battery, and/or the available space on a hard disk or a memory, may be represented by use of inherent information of the concerned system.

It may be preferable, though not necessary, that this information appear in a position that draws the user's attention. As illustrated in FIG. 1, the representation may be output in a part of a working window in which the user is currently working, such as a task bar. Or, the representation may be output in a working bar which can be constantly seen through a monitor or an LCD window. Further, it is also possible to change the colors of the background picture to convey the information.

Information referenced in this specification has an inherent property in that it continuously changes, rather than representing a fixed value. In the case in which a remaining time until an appointed time is shown, this implies that the remaining time until the appointed time is continuously shortened. In the case of the remaining power of a battery, this implies that the quantity of the battery is continuously decreased through use. In the case of weather, a value such as temperature continuously changes. In the case of stocks, a value such as the market price of a stock often, if not continuously, changes. A specific person's position changing over time is another example of a value that may be represented. Time and positioning information is merely described by way of example in these embodiments, however, and the present invention will not be limited thereto.

In the case of the output pattern, changes in colors are also applicable in a variety of manners. By coordinating the period of flickering, the flickering may become more rapid as the specific target value is approached. The output pattern referenced in this specification represents continuous changes of information, rather than a fixed value.

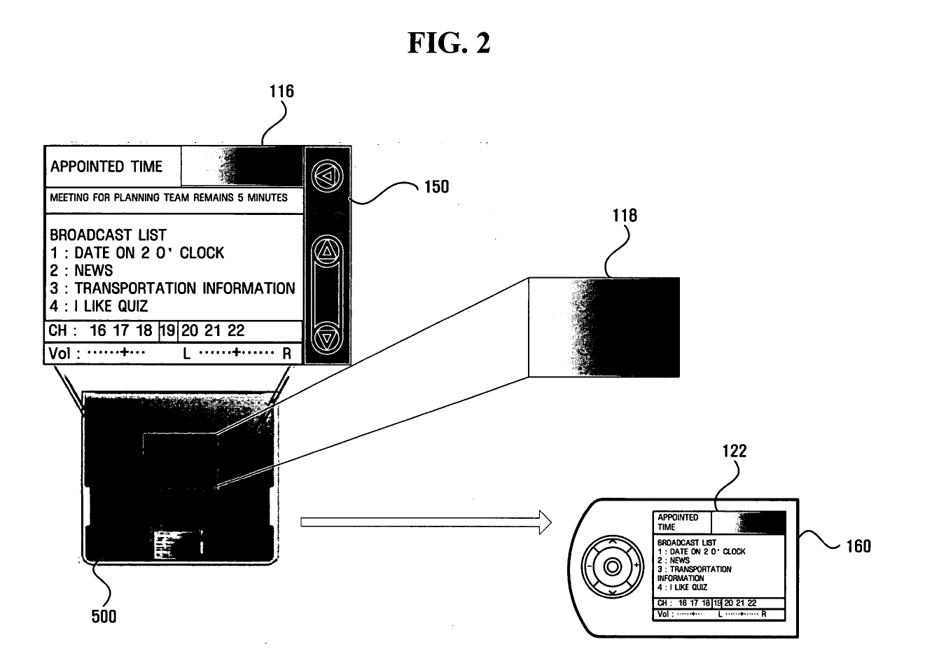

FIG. 2 is a block diagram illustrates notification of the approach of an appointed time using an analog representation in an auxiliary or an external device according to an embodiment of the present invention.

Unlike the embodiment in FIG. 1, which displays messages through specific windows,

FIG. 2 illustrates an embodiment using hardware units. Messages comprise information displayed through hardware units which will be described later.

FIG. 2 illustrates various external windows which may be present in a device such as a notebook computer 500. The output the notification of the approach of the appointed time in an external display 150 employing an EMA part will be described in the following. As shown in the window numbered 116 (Window 116), colors of a specific part of the EMA are changed. As described in connection with FIG. 1, a change of bright blue to dark blue would be one possible example. In addition to the EMA, a part of an output window of an external controller (such as a remote control) 160 to control the notebook computer may be changed.

Dedicated display portions other than the EMA windows or the remote control display may also be used, as embodied in the window numbered 118 (Window 118). For example, a message may be output on an OLED display. It can be easily shown that the appointed time is approaching through changes in attributes such as the intensity of the colors output as described above. Likewise, the remaining power of the battery can be indicated in the same manner as described above.

The color of an EMA window or the color of a part of an output window of an external controller may also represent messages, and changes in these colors are examples of an output pattern.

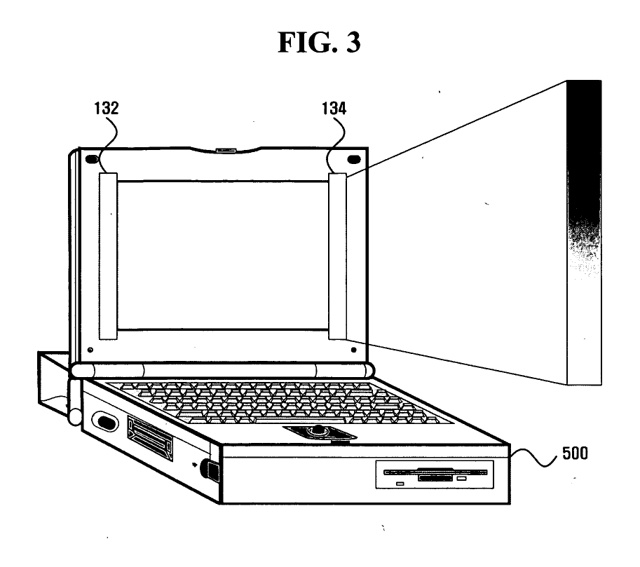

FIG. 3 is a block diagram illustrating the notification of the approach of an appointed time using analog representation in an auxiliary or a display window according to another embodiment of the present invention. FIG. 2 is an example illustrating the display of the information in an external display window mounted on an external face of a notebook computer 500 or a remote control 160.

Unlike FIG. 2, FIG. 3 illustrates output through auxiliary display windows 132 and 134 adjacent to the user's main display, by way of example. Auxiliary displays 132 and 134, which may be OLED displays, are present at both sides of the main display of the notebook computer 500. When, for example, the appointed time approaches while a user is working, the remaining power of the battery is becoming depleted, the price of a stock of interest approaches the target price set in advance, or a number of other quantifiable events, the auxiliary displays become a darker color.

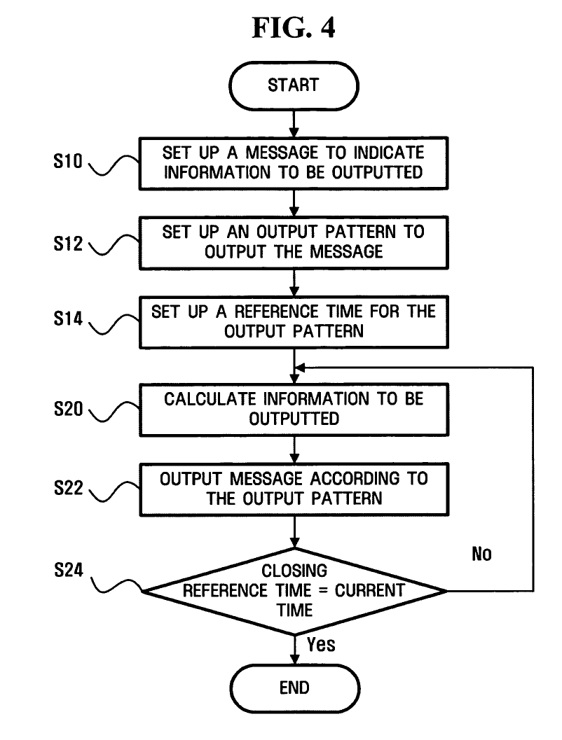

FIG. 4 is a flow chart illustrating the continuous display of information according to an embodiment of the present invention. A message that represents information to be output is first set S10. The information to be output may comprise such information as an appointed time, the remaining power of a battery, a price of a stock, weather information, the distance to a specific person or building, and/or other possible quantifiable events. A specific character, picture, or moving picture may be the message.

To output a message using analog representation, an output pattern is set S12. The output pattern may be controlled by software using a main display of a computer, PDA, or cellular phone (described with reference to FIG. 1), or it may be controlled by hardware using an external EMA window of a notebook computer, a window of a remote control, or auxiliary displays mounted on one or both sides, or the top and/or bottom, of the main display (described with reference to FIGS. 2 and 3). Whether to change the colors or saturation may be determined. The output pattern may also be set according to changes in another value.

A boundary value may be set in the output pattern. Changing colors may involve such transitional color changes as yellow being first outputted, and red then being outputted as time changes. Regarding brightness, a start value and the maximum value or a target value may be set. Color values may increase or decrease by use of an RGB color table. In addition to changes in colors, the rate of flickering, intensity of illumination, saturation, luminosity and brightness, and/or other values may be coordinated. Also, the size of a specific icon may be gradually enlarged. Gradual enlargement of the icon is applicable when the message consists of a moving picture.

Next, a reference time for an output pattern is set S14. Once an appointed time is set, a determination is made whether to output the output pattern a specific time period prior to the appointed time, or to output the output pattern starting from the entry of the reference time so as to continue the output pattern from then until the appointed time. The hour and the minute constituting the appointed time may be incorporated into the reference time of the output pattern. The current time may be the start reference time when no time is set.

In indicating the remaining power of a battery, the time at which the remaining power of the battery is at the maximum may be the start reference time, and the time at which the power of the battery is completely consumed may be the closing reference time. The reference time may be direct time data as regarding the appointed time, or it may imply the time at which there is a specific change in the information. In the location tracking example, the time at which a person is 100 m way could be the start reference time of an output pattern, and the time at which he or she arrives at a destination could be the closing reference time of the output pattern.

When the settings of operations S10, S12 and S14 are complete, information to be output is calculated S20. The information to be output could be how much time remains until an appointed time, where a specific person is currently located, how much power remains in a battery, and/or other such values. The information may be received through communications, or it may be determined through internal calculations.

Information represented in this embodiment of the present invention comprises information that is reviewed using a subject digital device, information such as the time that remains until an appointed time, the remaining quantity of a battery, and/or other such values, in addition to digital broadcast information and information received through an external server.

In operation S22, the calculated information is output according to the output pattern set in operation S12. For example, if an output pattern is defined as outputting colors that continuously change, the extent to which the colors change (in terms of numerical RGB values) is calculated and then outputted in operation S20. For example, if an appointed time is 5:00 pm, the start reference time of an output pattern is 4:00 pm, and the current time is 4:30 pm, a half hour has elapsed since the start reference time, and thus, a calculation to represent this situation is required. In another example, information to indicate a person or thing approaching a specific building may be needed.

Finally, if the closing reference time is the same as the current time, the output is discontinued S24. However, if the closing reference time is not same as the current time, the information to be output is again calculated so as to represent continuous change.

FIG. 4 is a flow chart illustrating a method to output a message in a case in which a unit responsible for setting information and a unit to output the message are present in a single digital device. However, analog representation does not require that the message be set and output in a single digital device. For example, in the case of a home network, a server may be available to send and/or receive communications (including data communications) with many home electric appliances. In a ubiquitous environment, information set by a server and output can be used by a variety of different devices.

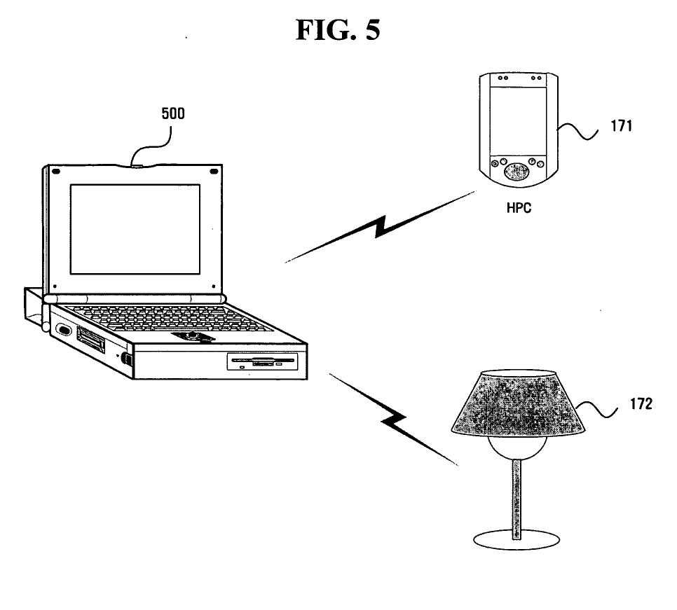

FIG. 5 is a block diagram of a system to display data in a user-friendly manner through a server and a client according to an embodiment of the present invention.

In FIG. 5, the setting of a message and an output pattern is conducted through a notebook computer 500. In this system, a handheld PC (HPC) 171 or a lamp 172 plays a role of displaying data to the user.

In FIG. 5, a set-up operation, such as illustrated in FIG. 4, is conducted in the notebook computer 500. An example of FIG. 4 is location tracking of a family as they approach home. It is assumed that global positioning is possible by means of a cellular phone that a member A of the family possesses. When A is to some degree close to home, the distance to home can be gradually represented. For example, the position of A from the time when A is 1 km away from home to when A arrives at home can be output. The set-up operation performed by the notebook computer is as follows. A message to represent information to be output is set in operation S10 of FIG. 4. Information to be output will be A's current position. Tracing the current position is possible through the cellular phone that A has. In the case of HPC 171, a specific area of a menu bar or a background picture, or a portion of an external display of the HPC to display change in the form of color, may be used. In the case of a lamp, the light can be used.

An output pattern to output a message is set in operation S12. In the output pattern, the HPC 171 and/or the lamp 172 may be set as output devices. How to output the message is determined depending upon the output device. In the HPC 171, it may be set that the message is gradually outputted on the menu bar or the title bar. In the lamp 172, it may be set that the light is gradually dimmed or brightened. The start and end values are set as boundary values. In the case of the HPC 171, it may be set that the color of the title bar is changed from a bright color to a dark color. In the case of the lamp 172, the light may be changed from a state in which it is initially turned off to a state in which it is at maximum brightness. Also, when the output reaches the target value a specific pop-up window may appear in the HPC, or the light may flicker.

After all the set-ups are complete, the reference time of the output pattern is set. The start reference time of the output pattern is the time at which A is 1 km away from home. When A comes home, the closing reference time of the output pattern is the time at which the distance between A and home is 0.

After this setup, information to be output is calculated in operation S20. As described above, the information to be output is A's current position, and this information can be received through communications and then used in the calculations. Calculation of the information to be output varies depending upon an output device; independent processing in the HPC 171 is possible. Since the HPC 171 has a communication function, it can immediately perform global positioning by means of a cellular phone. Global positioning is possible through a cellular phone or a notebook computer. A's positioning information is received through the notebook computer 500, and on this basis the color to be output on the title bar is calculated.

Since the lamp 172 usually has no function for complicated communication, the data is therefore received through the notebook computer 500, and the brightness of the lamp 172 can be adjusted using this data.

A message is output according to the output pattern in operation S22. As set in the above operations, the message may be output through the menu bar of the HPC 171 and/or the light of the lamp 172.

Since independent processing is possible in the HPC 171, the current position can be calculated and output. However, the lamp 172 conventionally lacks a function for independent processing, so calculation for output in operation S20 may be conducted in the notebook computer 500. When the notebook computer 500 calculates the position and communicates the information to the lamp 172, the lamp adjusts the light so that it corresponds to the received information.

After the outputting of the information in operation S22, if it is determined in operation S24 that the closing reference time of the output pattern is different from the current time, the information to be output is calculated again. When the closing reference time of the output pattern is the same as the current time, no further progress can be made and the operation is discontinued.

The method illustrated in the flow chart of FIG. 4 includes operations to select and set information to be sent to a user, set up an output pattern, calculate information to be output, and output the information according to the output pattern in a single process. These operations can be conducted within a single digital device, such as a notebook computer, a cellular phone, a computer, and others. However, this does not imply that these operations are necessarily conducted in the single digital device. As in the example of the HPC 171 of FIG. 5, the selection and setup of the information may be conducted by a device such as the notebook computer 500, and calculation and output of the information may be conducted by the HPC 171. As understood from the example of FIG. 5, the selection, setup, and calculation of the information may be conducted in the notebook computer 500, and only an output operation may be conducted in the lamp 172. Here, the notebook computer 500 functions as a server, and the HPC 171 and the lamp 172 function as clients, and the operations depicted in FIG. 4 are assigned thereto. In the case of a home network or a ubiquitous environment, this is applicable in a variety of manners. Examples of functions of the server and the clients will now be described.

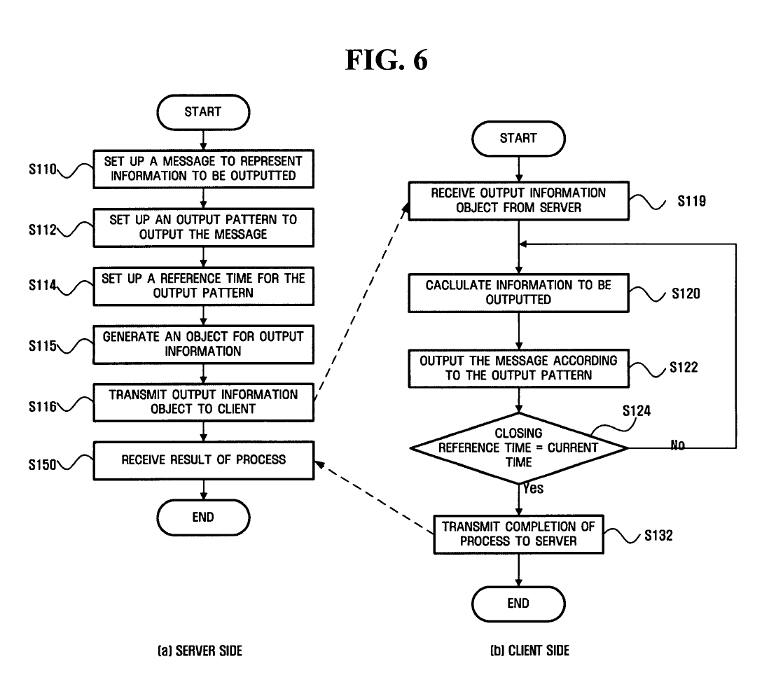

FIG. 6 is a flow chart illustrating a method of setting a message and an output pattern in a server according to an embodiment of the present invention.

In FIG. 6, (a) illustrates a flow of operations conducted on the server side. Operations S110 to S114 conduct a set-up operation as described in S10 to S14 of FIG. 4, and, thus, those operations may be performed as described in reference to operations S10 to S14 of FIG. 4. However, since the message set in operation S110 will not be output to a user from the server side, it further comprises information on how the information should be output (through which client), in accordance with the client's environment. For example, the information will be output from the HPC 171 (a client), and by changing the color of the HPC's 171 menu bar or a background picture, the information is displayed.

In operation S115, the generated object to output information is not output to the user from the server, but rather is output from the client. Thus, an object to output the information is created on the server side. The output information object comprises information set in steps S110 to S114. The output information object is created and transmitted to the client S116. After the client conducts an output operation with the received output information object, the server receives results of the processing S150 and then discontinues the operation.

In FIG. 6, (b) illustrates a flow of operations conducted on the client side. An output information object including information set by the server in operations S110 to S114 is received from the server S119. The object includes an output pattern and information regarding how to output information. After analyzing the output information object, the client determines a certain value is needed to calculate information to be output S120. According to the calculated result, the client outputs information according to the determined output pattern S122, and checks whether the closing reference time is the same as the current time S124. If it is, the client sends the server the processing result and information notifying that the output is complete. If it is not, the client returns to operation S120 to calculate the output information again. Calculation of the output information implies the same situation as in the example of FIG. 5 in which the HPC 171 directly receives global positioning information. Also, the HPC 171 directly receives and calculates weather information. Also, the time remaining to the appointed time may be calculated by means of an internal timer.

In the method shown in FIG. 6, set-up is conducted in the server, and reception and processing of changing values, and output, are conducted in the client. Operations between the notebook computer 500 and the HPC 171 shown in FIG. 5 are an example. In the flow chart of FIG. 6, the client is preferably, though not necessarily, able to independently receive or calculate the current value. In the example of FIG. 6, using the global positioning result, the HPC 171 directly receives the global positioning result. Also, to inform a user of the time remaining until an appointed time, the HPC calculates and outputs passing of the appointed time through an internal time module.

FIG. 6 only depicts setup by the server, but the server can set a message and an output pattern, and calculate information to be output, and the client can output the calculated information according to the output pattern. This implies that operations S119 and S120 of FIG. 6 may be conducted by the server.

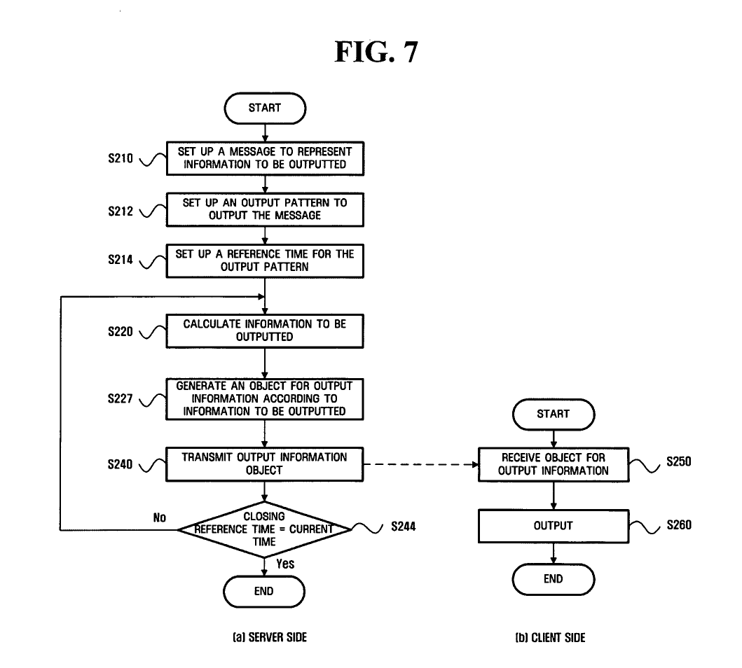

FIG. 7 is a flow chart of a method to set-up a message and an output pattern of the message, and to calculate output information on a server side according to an embodiment of the present invention.

In FIG. 7, (a) depicts operations conducted by the server. Operations S210 to S220 implement the same operations as in operations S10 to S20 of FIG. 4, and, thus, these operations may be performed as described in reference to operations S10 to S20 of FIG. 4. However, since the set message in operation S210 will not be output to a user from the server side, it further comprises information on how to output the information (through which client), according to the client's environment. For example, the information may be output from a lamp (a client), and the information will be displayed by coordinating the light of the lamp.

When the calculation of information to be output in operation S220 is completed, it is necessary to then send the information to the client. Thus, an object for outputting information is created S227. The output information object may include information regarding how to represent the output information with light, by calculating the difference between the current time and the appointed time, if the appointed time is represented by the light of a lamp. When the client is incapable of calculating the percentage difference between the current information, the start reference time and the closing reference time of an output pattern, or of calculating the information to be output, the server determines which mechanism to use to output the information, creates an object for outputting the information, and transmits it to the client S240. The server determines whether the current time is the same as the closing reference time of the output pattern. If different, the server returns to operation S220 to again calculate information to be output. If the times are the same, the operation is completed and discontinued.

In FIG. 7, (b) depicts operations conducted by the client. The client receives the output information object S250, including information to be output by the server through operations S210 to S227, and outputs the information according to information included in the message object S260. Examples of the information included in this message object are: brightness of the light, the period of flickering of the light in the case in which the client is a lamp, and the color of the screen in the case in which the client is a cellular phone.

The client of FIG. 7 requires less functions than the client of FIG. 6 because it does not have to receive in formation before calculations are made, or calculate information to be output, as the server receives and processes the output value according to the output pattern. Thus, it is applicable to devices such as lamps, wrist watches, and others lacking the necessary calculation functions. It is natural that digital devices having these and/or similar functions, such as HPCs, can function as clients. To process information included in digital broadcasting signals, the notebook computer 500 can receive broadcasting information and transmit the output information to the HPC, the cellular phone, and other such clients.

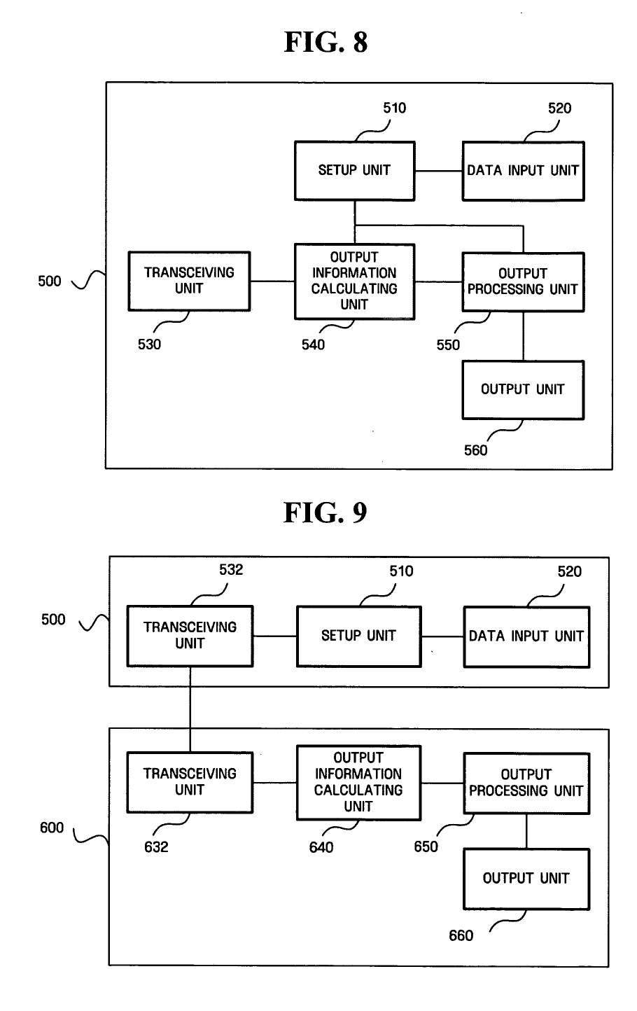

FIGS. 8 to 10 are block diagrams illustrating embodiments of FIGS. 4, 6 and 7.

The term “unit,” or “module”, as used herein, may refer to, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, components and modules may be embodied in order to implement one or more computers within a communication system.

FIG. 8 is a block diagram illustrating a structure of a server according to an embodiment of the present invention. Referring to this figure, setting a message and an output pattern, and calculating and outputting information, are conducted in a single digital device.

A server 500 comprises a set-up unit 510, a data input unit 520, a transceiving unit 530, an output information calculating unit 540, an output processing unit 550, and an output unit 560.

The setup unit 510 sets a message to be output, an output pattern, and a reference time of the output pattern. This is conducted through the data input unit 520. In the case in which the server is a notebook computer, the data input unit 520 may be a device such as a keyboard or a mouse. In the case in which the server is a cellular phone, the data input unit 520 may be a keypad of the cellular phone. In addition, a default value inherently provided in a system may be used for the set-up by the setup unit 510.

Calculation of a value of the current information to be outputted using the information set by the setup unit 510 is conducted in the transceiving unit 530 and the output information calculating unit 540. If the information to be outputted, such as stock prices, weather, and global positioning information, is to be received through communications, rather than being calculated inherently by the server, data input through the transceiving unit 530 can be processed by the output information calculating unit 540. In addition, values such as the time remaining before an appointed time, and/or the remaining power of a battery, which can be inherently calculated, may be received from a module in order to conduct the concerned calculation or measurement.

The output processing unit 550 reviews the received information, and the message and output pattern set in the set-up unit 510, and conducts a calculation according to the message (such as title bar or background picture, or external or auxiliary display) and the output pattern (such as color, flickering, size of an icon), and sends them to the output unit 560.

The output unit 560 may be a main display, or an external or auxiliary display according to the output mode. The message may be a part of the output unit and a part of software or hardware.

FIG. 9 is a block diagram illustrating a structure of a server and a client according to an embodiment of the present invention.

The server is as shown in FIG. 6(a), and the client is as shown in FIG. 6(b).

The setup unit 510 of the server 500 sets a message to be output, an output pattern, and a reference time of the output pattern. This is conducted through the data input unit 520. In the case in which the server is a notebook computer, the data input unit 520 may be a device such as a keyboard or a mouse. In the case in which the server is a cellular phone, the data input unit 520 may be a keypad of the cellular phone. In addition, a default value inherently provided in a system may be used for the set-up by the setup unit 510.

The server creates an object of output information to send the setup information to the client. The transceiving unit 532 transmits the output information object to the client.

The client 600 receives, through the transceiving unit 632, the output information object sent by the server 500. If the output information is to be received through external communications, the transceiving unit 632 has to receive the information. The output information calculating unit 640, the output processing unit 650, and the output unit 660 perform output functions of the server in FIG. 8, and the client has substantially the same functions as the output information calculating unit 540, the output processing unit 550, and the output unit 560 of FIG. 8, and, thus, description thereof will be omitted.

Examples of the server and the client of FIG. 9 may be a notebook computer and a cellular phone, or a computer and a wrist watch, respectively.

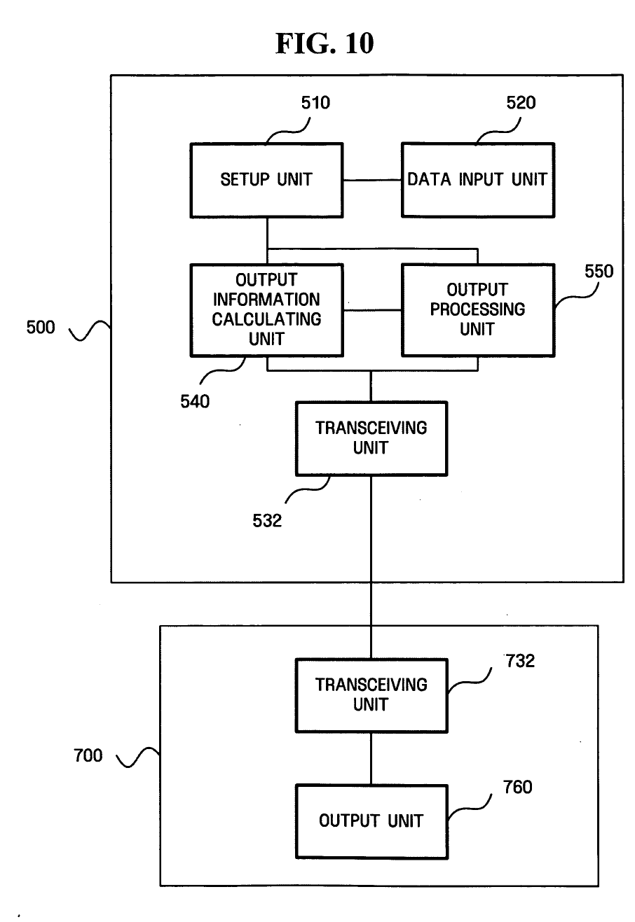

FIG. 10 is a block diagram illustrating a structure of a server and a client according to another embodiment of the present invention.

The server is as shown in FIG. 7(a), and the client is as shown in FIG. 7(b). As described with respect to FIG. 8, the setup unit 510, the data input unit 520, the output information calculating unit 540, an output processing unit 550, and a transceiving unit 560 has substantially the same functions as those of FIG. 8.

The setup unit 510 may further comprise a function to set information through which the message is output. To output the message through the client, the output processing unit 550 creates an object and transmits this object to the client 700 through the transceiving unit 532. Unlike the client of FIG. 9, the client of FIG. 10 has a transceiving unit 732 having a basic function for transmission and reception, and an output unit 760 to output the output information received through the transceiving unit.

Examples of the server and the client of FIG. 9 may be a notebook computer and a lamp, or a computer and an alarm watch or an HPC.

According to the present invention, a user can easily recognize changes in information by receiving user-friendly information.

According to the present invention, changes in information can also be usefully provided to those who are accustomed to an analog mechanism.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of providing information in a user-friendly manner to a user of a digital apparatus, the method comprising:
providing an output pattern applicable to a message to be outputted;
providing a reference time on which changes in the output pattern are based; and
outputting the message by continuously changing the output pattern according to a time difference between a predetermined time and the reference time.

2. The method of claim 1, wherein the message to be outputted comprises any one of text, a picture, a moving picture, on/off information, or a combination thereof.

3. The method of claim 1, wherein the message to be outputted is represented by any one of a title bar of a working window of the digital device, a background picture, an external window, a lamp whose brightness of light or color is coordinated with the message, or a combination thereof.

4. The method of claim 1, wherein the message to be outputted is represented on an external display of the digital device.

5. The method of claim 1, wherein the output pattern comprises information necessary to output the message.

6. The method of claim 1, wherein the output pattern comprises coordination between the message and any one of saturation, luminosity and brightness, RGB colors, intensity of illumination of light, volume of sound, or a combination thereof.

7. The method of claim 1, wherein the reference time comprises a start reference time of the output pattern on which basis the output pattern starts changing.

8. The method of claim 1, wherein the reference time comprises a closing reference time of the output pattern on which basis the output pattern stops changing.

9. The method of claim 1, wherein the message to be outputted represents information continuously changing as time passes.

10. The method of claim 1, wherein the message to be outputted represents information continuously received through communication.

11. A digital apparatus, comprising:
a setup unit to set a message to be outputted, an output pattern to be applied to the message, and a reference time on which changes in the output pattern are based; and
an output unit to output the message by continuously changing the output pattern according to a time difference between a predetermined time and the reference time.

12. The apparatus of claim 11, wherein the message to be outputted comprises any one of text, a picture, a moving picture, on/off information, or a combination thereof.

13. The apparatus of claim 11, wherein the message to be outputted is represented by any one of a title bar of a working window of the digital device, a background picture, an external window, a lamp whose brightness of light or color is coordinated with the message, or a combination thereof.

14. The apparatus of claim 11, wherein the message to be outputted is displayed on an external display of the digital device.

15. The apparatus of claim 11, wherein the output pattern comprises information necessary to output the message.

16. The apparatus of claim 11, wherein the output pattern comprises coordination between the message and any one of saturation, luminosity and brightness, RGB colors, intensity of illumination of light, volume of sound, or a combination thereof.

17. The apparatus of claim 11, wherein the reference time comprises a start reference time of the output pattern on which basis the output pattern starts changing.

18. The apparatus of claim 11, wherein the reference time comprises a closing reference time of the output pattern on which basis the output pattern stops changing.

19. The apparatus of claim 11, further comprising an output information calculating unit to calculate information;
wherein the message to be outputted represents information continuously changing as time passes.

20. The apparatus of claim 11, further comprising a receiving unit to receive information;
wherein the message to be outputted represents information continuously received through communication.

21. A digital apparatus, comprising:
a setup unit to set a message to be outputted, an output pattern to be applied to the message, and a reference time on which changes in the output pattern are based; and
a transmitting unit to transmit, to a client, an object including the message, the output pattern, and the reference time.

22. A digital apparatus, comprising:
a receiving unit to receive from a server an object including a message to be outputted, an output pattern, and a reference time; and
an output unit to output the message by continuously changing the output pattern according to a time difference between a predetermined time and the reference time.

23. The apparatus of claim 22, wherein the output unit refers to an external display.
